(19) United States
(12) Patent Application Publication
(10) Pub. No.: US 2018/0365729 A1
(43) Pub. Date: Dec. 20, 2018

(54) Computerized method and apparatus for maximizing sales of consumer goods, and for optimizing recurring-expenses by considering multiple parameters

(71) Applicant: Papa Rao S. Avasarala, Smyrna, GA (US)

(72) Inventor: Papa Rao S. Avasarala, Smyrna, GA (US)

(21) Appl. No.: 15/998,040

(22) Filed: Jun. 15, 2018

Related U.S. Application Data
(60) Provisional application No. 62/604,019, filed on Jun. 20, 2017.

(51) Int. Cl. G06Q 30/02

(52) U.S. Cl. CPC G06Q 30/0244; G06Q 30/0202

(57) ABSTRACT

A computerised method and apparatus for increasing/optimizing retail market share/sales of a retailer/service provider and for decreasing/optimizing advertising expenses, include the steps/modules for (a) creating and entering an advertisement-response model including parameters reflecting present/historical ad-expense, present/historical sales and present/historical promotions/incentives of said retailer into a programmed computer to obtain at least a first output; (b) creating and entering into said programmed computer a demand-forecast model including predetermined market-related parameters to obtain a second output, said at least first output being connected for ongoing processing; and (c) using said first and second outputs as computerized inputs into an advertisement expense-optimizer model to obtain a recommendation of permissible/projected future total advertisement expenses for said retailer/service provider. Each of the above steps/modules includes programmed models taking into account present/historical parameters to provide optimized figures for Ad expenses and sales figures.

### RELATED APPLICATION

This application claims priority from U.S. Provisional Application 62/604,019 filed on Jun. 20, 2017, the contents of which are incorporated herein by reference.

### FIELD OF THE INVENTION

This invention relates to method and apparatus for maximizing sales and simultaneously optimizing/minimizing recurring expenses such as advertising and promotion costs, by taking into account multiple parameters. The sales could relate to any consumer product such as automobiles or other non-tangible service goods such as vacations. The recurring expenses could include, for example, advertising costs in different media (such as radio, television, printed flyers/brochures and other periodical/monthly occurring costs including recurring promotion costs. The sales could relate to automobiles, recreational vehicles, boats, etc. The automobiles could include those from different manufactures, national and worldwide, marketed through different channels in local markets.

The parameters could include but are not limited to effectiveness of channels/media, as well as prediction figures. The prediction figures might include forecasts of general demand, advertising expenses, product-demand, and demand-variation by season/month of the year.

### BACKGROUND OF THE INVENTION

Retailers that do marketing of services and consumer goods allocate and spend a significant amount of money on advertising, to sustain and increase market-share/sales. While advertising-expenditure may be viewed as an important or even a critical business-consideration to drive market-share/sales, there are many factors/parameters that influence the effectiveness of the advertising expense (herein also referred to as Ad expense). Advertising expense that does not consider these influencing factors/parameters will not always yield the desired share/sales results and might further result in wastage of advertising expense. A typical retailer utilizes several advertising channels (herein “channel”) that might typically include network television, cable television, radio, newspaper, direct mail, mobile advertisements, online radio and on-line digital channels of search or display or video.

Further, the gains in market-share and therefore sales, depend on an understanding of the effects of the foregoing modes of advertizing and the corresponding expenditures relative to other market-factors.

### DESCRIPTION OF PRIOR ART

Prior art offers examples of efforts to address advertising expenses and market share. For example, U.S. Pat. No. 6,286,005, issued on Sep. 4, 2001 to Cannon, and titled “Method and apparatus for analyzing data and advertising optimization” teaches a computer based decision support system having three components, i.e., a database mining engine, an advertising optimization mechanism and a customized user interface.

U.S. Pat. No. 7,949,561, issued on May 24, 2011 to Briggs and titled “Method for determining advertising effectiveness” teaches cross-media campaigns and the effectiveness of different advertising media.

U.S. Pat. No. 9,208,462 B2, issued on Dec. 8, 2015 to Arunachalam et al and titled “System and Method for Generating a Marketing-Mix Solution” teaches a method including pre-modeling marketing data having a plurality of marketing-mix variables.

U.S. Pat. No. 9,824,367 B2, issued on Nov. 21, 2017 to Sollis et al and titled “Marketing Effectiveness of Marketing Campaigns across Multiple Channels” teaches measurement of on-line activity in connection with marketing.

### SUMMARY OF THE INVENTION

The present invention is directed to computerized method and apparatus for maximizing sales of consumer goods/services, and for optimizing recurring-expenses by considering multiple parameters. The invention in one broad form resides in a computerised method of increasing/optimizing retail market share/sales of a retailer/service provider for a known commodity and for decreasing/optimizing advertising expenses for said known commodity, comprising the steps of:

a, creating and entering an advertisement-response model including the parameters of present Ad-expense, present sales and present promotions/incentives of said retailer into a programmed computer to obtain at least a first output;
b. creating and entering into said programmed computer a demand-forecast model including predetermined market-related parameters to obtain a second output, said at least first output being connected for ongoing processing; and
c. using said first output and said second output as computerized inputs into an advertisement expense-optimizer model to obtain a recommendation of optimal future total advertisement expenses for said retailer/service provider.
For the purposes of this invention, the term “present”, in the context of “present ad-expense, present sales and present promotions/incentives”, is to be understood to include “historical” as well. In other words, from a time-perspective, the term “present” is meant to be understood to comprise all relevant historical parameters from the past including corresponding relevant parameters from the present.

The invention in another broad form resides in a programmed computer for increasing/optimizing retail market share/sales of a retailer/service provider for a known commodity and for decreasing/optimizing advertising expenses for said known commodity, said programmed computer comprising programmed models for:

a, creating and entering an advertisement-response model including parameters representing present ad-expense, present sales and present promotions/incentives of said retailer into a programmed computer to obtain at least a first output;
b. creating and entering into said programmed computer a demand-forecast model including predetermined market-related parameters to obtain a second output, the programmed computer being wired for further processing of said first output; and for
c. using said first output and second output as computerized inputs into an advertisement expense-optimizer-model to obtain a recommendation of permissible/projected future total advertisement expenses for said retailer/service provider.

In another form, the invention broadly comprises a programmed computer for increasing/optimizing retail market share/sales of a retailer/service provider for a known commodity and for decreasing/optimizing advertising expenses for said known commodity, comprising at least:

(a) a first programmed model for creating and entering into the programmed computer, an advertisement-response model including parameters representing historical/present ad-expense, present sales and present promotions/incentives of said retailer into a programmed computer to obtain at least a first output;
(b). a second programmed model for creating and entering into said programmed computer a demand-forecast model including predetermined market-related parameters to obtain a second output, said at least first output being connected as an input for further processing; and
(c) a third programmed model for using said first output and second output as computerized inputs into an advertisement expense-optimizer-model to obtain a recommendation of permissible/projected future total advertisement expenses, said total advertisement expenses being broken down separately by media-channel, by product and by geography, for said retailer/service provider.

Comparison of the present invention to prior art referenced above:

U.S. Pat. No. 6,286,005, issued on Sep. 4, 2001 to Cannon, focuses on decision support as opposed to making actual, specific advertising expense recommendations.

Cannon teaches storing data using a database, and retrieval of the data. Cannon provides a framework for ad-expense-scenario comparison using scoring of different options. In Cannon, the focus of the invention is on TV advertising using Nielsen ratings. This is a sample based approach, and there is no emphasis on use of product sales data. The focus is on reaching target audience without any measurement of product sales or product share increase. Moreover, in Cannon, there is no major consideration of use of any predicted demand for sales of product.

U.S. Pat. No. 7,949,561, issued on May 24, 2011 to Briggs and titled “Method for determining advertising effectiveness” teaches a method that focuses on the effectiveness of media advertising based on control vs. pilot group. In Briggs, there is no actual tie-in with sales data for the overall product sales or share. Also, in Briggs, there is no recommendation of any optimal mix of media channel and advertising expense for each channel. All the of algorithms in Briggs seem to be based on evaluation of ‘exposed’ and ‘control’ groups using an experimental design approach. The exposed and control group approach is a sampling based approach. The Briggs method provides dollar-for-dollar comparison of media channels as opposed to a specific recommendation of total expense, allocation of expense by channel tied to a sales/share target achievement. Further, Briggs does not teach any use of demand forecast for future product sales and change in forecast based on optimal allocation of advertising expenses.

U.S. Pat. No. 9,208,462 B2, titled “System and Method for Generating a Marketing Mix Solution” and issued on Dec. 8, 2015 to Arunachalam et al teaches a system and method considering only a sales and/or revenue based response model. There is no product market share component in Arunachalam et al, where additionally the system only looks at marketing mix and advertising expense of own product and not that of competitive products. The system and method in Arunachalam et al do not seem to consider a demand forecast for future sales of the product to compare against desired sales. In this prior art patent, the marketing mix solution focuses on pre-modeling and analysis of historical marketing mix and not on optimizing future marketing mix (advertising expense by channel) based on predicted need.

U.S. Pat. No. 9,824,367 B2, to Sollis et al issued on Nov. 21, 2017 and titled “Marketing Effectiveness of Marketing Campaigns Across Multiple Channels” teaches measurement of online activity. In Sollis et al, the multiple channels referenced are for offline campaigns that tie back to online activity. The Sollis invention does not seem to include traditional offline channels such as TV, Radio etc. The focus of the invention in Sollis et al seems to be B2B (business to business) and not B2C (business to consumer). Also the Sollis invention does not seem to include any future product demand forecast, nor any competitor effects. Nor does the Sollis invention seem to optimize advertising expenses as in the present invention.

In contrast, the market factors selectively considered in the context of a preferred embodiment of the present invention include without limitation at least the following parameters: number of competitors, competitive advertising channels, advertising expenditure from competitors, retailer's own incentives offered, competitive incentives offered, product ratings, retailer ratings, product trends, market demand, and retailer's own demand.

### BRIEF DESCRIPTION OF THE DRAWING

A more detailed understanding of the invention may be had from the following description of preferred exemplary embodiments, not intended to be limiting, and to be understood in conjunction with the accompanying drawing wherein:

FIG. 1 illustrates a high level method and apparatus of the present invention, including models identified herein as “Ad Response Model”, “Demand Forecast Model” and “Ad Expense Model”.

FIG. 2 shows an expanded illustration of an “Ad Response Model” according to one embodiment of the invention;

FIG. 3 shows an expanded illustration of a “Demand Forecast” model according to one embodiment of the invention; and,

FIG. 4 shows an expanded illustration of an “Ad Expense Optimizer” model according to one embodiment of the invention.

### DETAILED DESCRIPTION OF A PREFERRED EMBODIMENT

A detailed description of one or more embodiments of the invention is provided below in conjunction with the accompanying figures that illustrate by way of example the principles of the invention. While the invention is described in connection with such embodiment/s, it should be understood that the invention is not limited to any particular embodiment. On the contrary, the scope of the invention is limited only by the appended claims and their equivalents, and the invention encompasses numerous alternatives, modifications and equivalents. For the purpose of example, numerous specific details are set forth in the following description in order to provide a thorough understanding of the present invention.

The present invention may be practiced according to the appended claims without some or all of these specific details. For purposes of clarity, computers/programming and related technical material that are known in the technical fields related to the invention have not been described so that the present invention is not unnecessarily obscured.

### Invention/Solution Summary

The present inventive software, among other aspects, provides retailers with feedback and recommendations on advertising expense by considering certain parameters that influence the effectiveness of advertising. The key parameters that the present invention solution will include for consideration that will enhance the organized effectiveness of advertising comprise, but are not limited to:

1. Historical share/sales

2. Historical advertising expenses by different media channels

3. Historical promotions and incentives

4. Historical local-market economic indicators

The above parameters in the present invention are useful for the retailer/dealer/merchant and the rest of the market to measure the market-response to efforts to advertise, under different conditions.

The present inventive software targets among other things, to

1. Increase/optimize retail market share/sales
2. Decrease wastage of advertising expense

For example, with the present inventive software, new-car dealers will be able to increase their market share while maintaining/optimizing their advertising expense levels; and/or, new-car dealers implementing the invention might be able to maintain their market-share while minimizing advertising expense

It is noted that herein, “Ad” is used as an abbreviation for “Advertisement” It is also noted that “Expense” and “Spend” (in a noun form) may be used in the text and drawings synonymously.

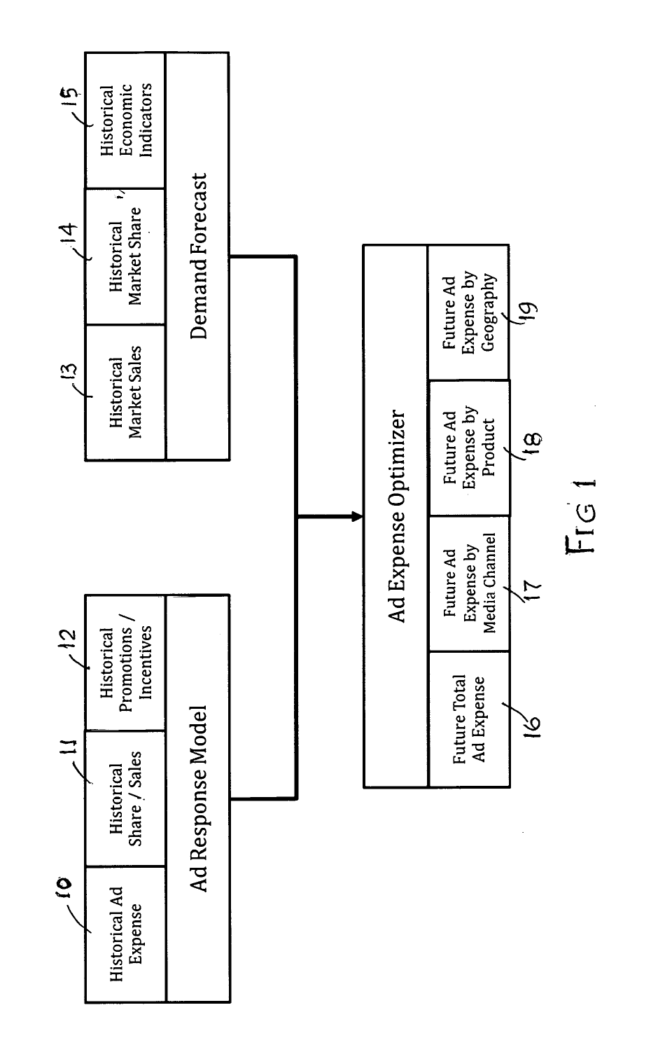

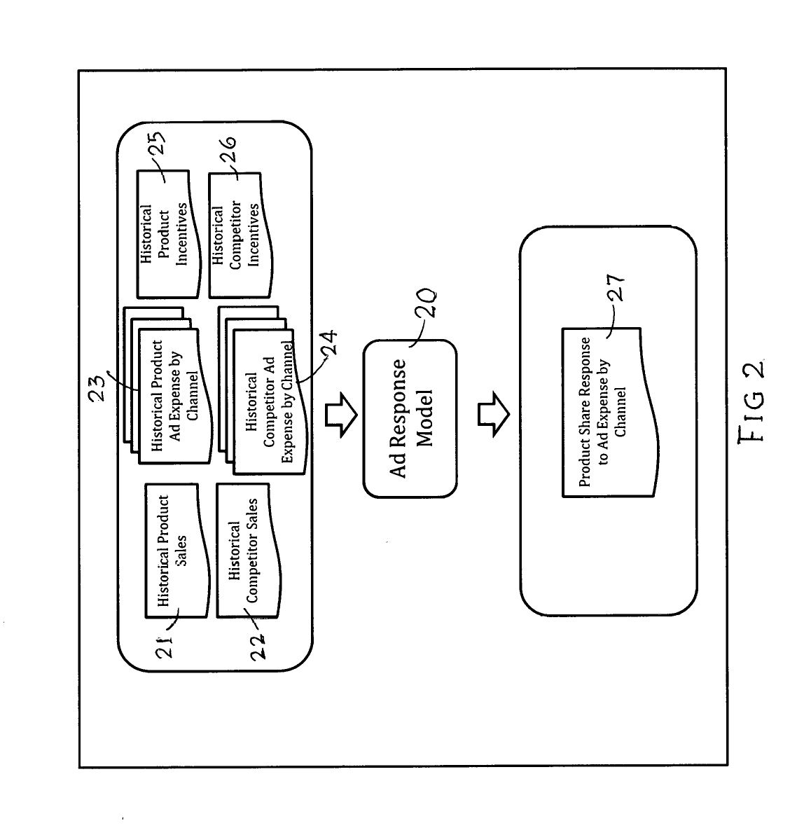

FIG. 1 shows a high-level rendition of the Market-Scope Solution of the method and apparatus of the present invention including three key models of Ad Response Model, Demand Forecast and Ad Expense Optimizer. Therein, the Ad Response model measures the effectiveness of advertisements on the market share, and might comprise Present Ad Expense, Present Share/Sales and Promotions/Incentives as shown. The Demand Forecast model provides a forecast of future share/sales at the product level. The Demand Forecast Model might comprise Future Market Sales, Market Share as well as Economic Indicators. The Ad Response model might include the Future Total Ad Expense, Ad expense by Media Channel, Ad Expense by Product and Ad Expense by Geography. The three models of Ad Response Model, Demand Forecast and Ad Expense Optimizer might include other parametric blocks not illustrated in FIG. 1 but are intended to be within the scope of the present invention. As illustrated in the context of one exemplary embodiment, the Ad Response Model in FIG. 1 includes Ad Expense block 10, Share/Sales block 11, and Promotions/Incentives block 12. Further, as shown in FIG. 1, the Demand Forecast Model includes Market Sales block 13, Market share block 14 and Economic Indicator block 15. As exemplarily shown in FIG. 1, the Ad Expense Optimizer includes Total Ad Expense block 16, Ad Expense by Media-Channel block 17, Ad Expense by Product block 18 and Ad Expense-by-Geography block 19. The above three key models of Ad Response Model, Demand Forecast and Ad Expense Optimizer are explained in greater detail in the context of FIGS. 2, 3 and 4.

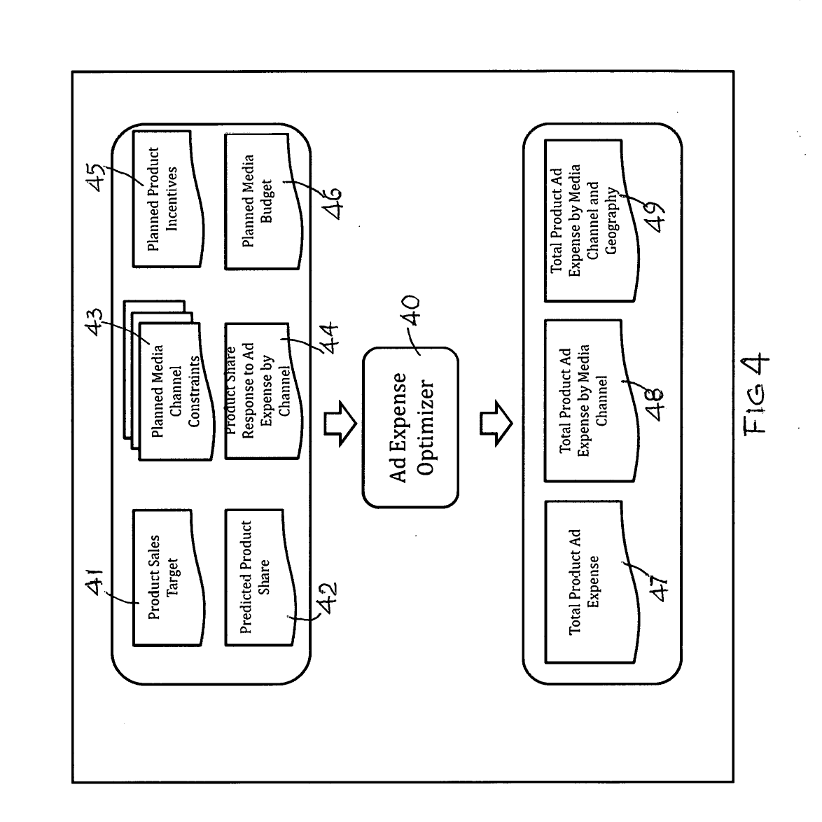

FIG. 2 generally illustrates for example, the Ad Response Model 20. Shown in further detail in FIG. 2 are Historical Product Sales block 21, Historical Competitor Sales block 22, block 23 dedicated to Historical Product Ad spend/expense-by-channel, block 24 dedicated to Historical Competitor Ad spend/expense by Channel, and block 26 dedicated to Historical competitor incentives. Additionally, FIG. 2 shows block 27 dedicated to Product Share Response signal feeding Ad spend/expense by Channel block in FIG. 4.

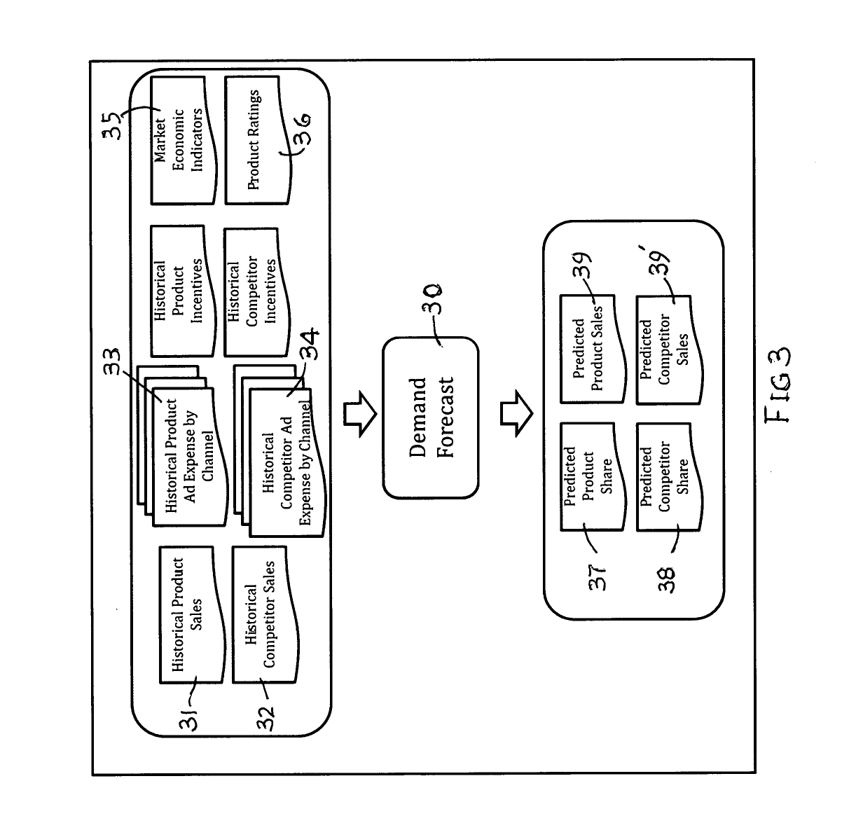

FIG. 3 illustrates one exemplary detail of the Demand Forecast Model. As shown, the Demand Forecast Model 30 includes the following distinct blocks: 31 for Historical Product Sales, 32 for Historical Competitor Sales, 33 for Historical Ad spend/expense by Channel, 34 for Historical Competitor Ad spend/expense by Channel, 35 for Historical Product Incentives, and 36 for Historical Competitor incentives. FIG. 3 also illustrates block 37 dedicated to Predicted Product Share which in turn feeds a signal to Ad spend/expense Optimizer 40 at block 42. FIG. 3 further includes block 38 for predicted competitor share, 39 for predicted product sales and 39′ for predicted competitor sales.

FIG. 4 illustrates one exemplary detail of Ad Expense Optimizer 40 model. As shown, Ad Expense Optimizer 40 exemplarily includes the following blocks: 41 for Product Sales Target, 42 for Predicted Product Share which receives a signal from block 37, 43 for Planned Media Channel Constraints, 44 for Product Share Response to Ad spend/expense by Channel, 45 for Planned Product Incentives, and 46 for Planned Media Budget. FIG. 4 further exemplarily shows block 47 for Total Product Ad spend/expense, block 48 for Total Product Ad spend/expense by Media Channel and block 49 for Total Product Ad expense by Media channel and Geography. Other parameters not specifically referenced above may be factored into the models 20, 30 and 40.

The Ad Response model 20, as aforesaid, measures the effectiveness of advertisements on the market share, and therein the share may be calculated as:

Share=Σf{own retail advertising expense,competitor retail advertising expense,own brand advertising expense,competitor brand promotions/incentives}

Share=α+ΣβᵢXᵢ+γ

where

### α=Constant

βᵢ=Coefficients
Xᵢ=Advertising Expense/(Advertising Expense+ρᵢ)
ρ=Share parameter value
γ=Error adjustment value
i=1 to number of advertising channels specified in the list

The Demand Forecast model 30, as aforesaid, provides a forecast of future share/sales at the product level. This may be calculated as:

Forecast=f{seasonality,trend,baseline share,market sales,own-promotions/incentives,competitor promotions/incentives}

The forecast utilizes a modified Holt-Winters method. which is developed to address seasonal demand with dynamic demand patterns, can operate on short history and reacts to recent changes in demand patterns. It is noted that

y₍ₜ₊₁₎=(lₜ+bₜ)s₍ₜ₋ₘ₎+dₐ

z₍ₜ₊₁₎=(lₜ+bₜ)s₍ₜ₋ₘ₎+dₐ

where
y₍ₜ₊₁₎=Forecast for period+1
z₍ₜ₊₁₎=Share forecast for period+1
lₜ=Level equation
bₜ=Trend equation
sₜ=Seasonality equation

lₜ=α(yₜ/s₍ₜ₋ₘ₎)+(1−α)(lₜ₋₁+bₜ₋₁)

bₜ=β(lₜ−lₜ₋₁)+(1−β)bₜ₋₁

sₜ=γ(yₜ/(lₜ₋₁+bₜ₋₁)+(1−γ)sₜ₋ₘ

dₐ=linear demand adjustment for static events, incentives
y=normalized historical demand
m=12 for monthly seasonality, 4 for quarterly
α, β, γ are smoothing parameters.
The output of the demand forecast model informs the system about expected sales for normalized reference conditions. In other words, demand is adjusted for minimum Ad expense, incentives and other static events.

Demand forecast is computed for product sales and total market sales of the entire competitive product set.

Product Market Share=(Product Sales/Market Sales of entire competitive product set)

The sales and market share computations support the input to the Ad Spend Optimizer component and facilitate the easy conversion of sales to share and vice versa.
The demand forecast is compared with target sales value or share target for future month's. Target sales is typically a business input. Target share S. is computed based on month over month share change.

Target share Sₒ=μ(Σ_{t=0,m}(|Shareₜ−Shareₜ₋₁|))

The Ad Expense Optimizer model 40, as aforesaid provides recommendations for Ad Spend/Expense by media channel at the product level for the future time period. This is calculated as:

Ad Spend/Expense by Media Channel=f{Demand Forecast,Ad Response,Baseline Ad Spend/Expense}

This is computed from the following optimization formulation:

Max ΣSᵢ

Sᵢ=share of product i

Sᵢ=α+ΣβᵢXᵢ+γ

Subject to constraints

zₜᵢ<Sₜᵢ<(Sₜᵢ+Sₒ).

General Applications of the Invention:

The principles of the foregoing invention with minor suitable modifications may be applied for any consumer product including consumer-products indicated above, with intent to result in increased market share/sales and optimized recurring expenses. In the foregoing detailed description of embodiments of the invention, various features may have been grouped together in a single exemplary embodiment for the purpose of streamlining the disclosure. This method of disclosure is not to be interpreted as reflecting an intention that the claimed embodiments of the invention require more features than are expressly recited in each appending claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled. In the appended claims, the terms “including” and “in which” where present, are used as the plain-English equivalents of the respective terms “comprising” and “wherein,” respectively. Moreover, the terms “first,” “second,” and “third,” etc., if used, are used merely as labels, and are not intended to impose numerical limitations/requirements on their objects.

1. A computerised method of increasing/optimizing retail market share/sales of a retailer/service-provider for a known commodity and for decreasing/optimizing advertising expenses for said known commodity, comprising the steps of:
a, creating and entering an advertisement-response model including parameters relating to present ad-expense, present sales and present promotions/incentives of said retailer into a programmed computer to obtain at least a first output;
b. creating and entering into said programmed computer a demand-forecast model including predetermined market-related parameters to obtain a second output, said at least first output being used for ongoing processing; and
c. using said first and second outputs as computerized inputs into an advertisement expense-optimizer model to obtain a recommendation of permissible/projected future total advertisement expenses for said retailer/service provider.

2. The computerised method as in claim 1 including the step of factoring (a) historical product/service Ad expense of said retailer by channel and (b) historical product/service Ad expense of a competitor by channel, to said advertisement-response model.

3. The computerised method as in claim 2 including the step of factoring (a) historical product sales of said retailer by channel and (b) historical competitor sales into said advertisement-response model.

4. The computerised method as in claim 3 including the step of factoring (a) historical product incentives of said retailer by channel and (b) historical competitor product incentives into said advertisement-response model.

5. The computerised method as in claim 1 including the step wherein said advertisement-response model generates a product share-response signal and connecting said product share signal response signal as input to said advertisement expense-optimizer model.

6. The computerised method as in claim 1 wherein said advertisement-response model takes into account product sales share computed as
Share=f{own retail ad expense,competitor retail ad expense,own brand ad expense,competitor brand ad expense,own promotions/incentives,competitor promotions/incentives}
Share being expressed as equivalent to α+ΣβᵢXᵢ+γ
where
α=Constant
βᵢ=Coefficients
Xᵢ=Advertising Spend/(Advertising Spend+ρᵢ)
ρ=Share parameter value
γ=Error adjustment value, and
i=1 to number of advertising channels specified in the list.

7. The computerised method as in claim 1 wherein said demand-forecast model takes into account
(i) a product demand forecast that utilizes Holt-Winters method expressed as
y₍ₜ₊₁₎=(lₜ+bₜ)s₍ₜ₋ₘ₎+dₐ
z₍ₜ₊₁₎=(lₜ+bₜ)s₍ₜ₋ₘ₎+dₐ
where
y₍ₜ₊₁₎=Forecast for period+1
z₍ₜ₊₁₎=Share forecast for period+1
lₜ=Level equation
bₜ=Trend equation
sₜ=Seasonality equation
lₜ=α(yₜ/s₍ₜ₋ₘ₎)+(1−α)(lₜ₋₁+bₜ₋₁)
bₜ=β(lₜ−lₜ₋₁)+(1−β)bₜ₋₁
sₜ=γ(yₜ/(lₜ₋₁+bₜ₋₁)+(1−γ)sₜ₋ₘ
dₐ=linear demand adjustment for static events, incentives
y=normalized historical demand
m=12 for monthly seasonality, 4 for quarterly
α, β, γ are smoothing parameters, and
(ii) demand forecast considering Target sales and Target share wherein
Sₒ=μ(Σ_{t=0,m}(|Shareₜ−Shareₜ₋₁|)) and
Sₒ=Target share.

8. The computerised method as in claim 1, wherein said advertisement expense-optimizer model takes into account Ad-expense by media-channel as being represented by: f {Demand Forecast, Ad Response, Baseline Ad Spend} using optimization formulation Max Σ Sᵢ, where Sᵢ=share of product i
Sᵢ=α+ΣβᵢXᵢ+γ,subject to constraints
zₜᵢ<Sₜᵢ<(Sₜᵢ+Sₒ).

9. A programmed computer for increasing/optimizing retail market share/sales of a retailer/service provider for a known commodity and for decreasing/optimizing advertising expenses for said known commodity, comprising programmed models for
a, creating and entering an advertisement-response model including parameters relating to historical Ad-expense, historical sales and historical promotions/incentives of said retailer into a programmed computer to obtain at least a first output;
b. creating and entering into said programmed computer a demand-forecast model including predetermined market-related parameters to obtain a second output, said at least first output being connected as an input for further processing; and for
c. using said first output and second output as computerized inputs into an advertisement expense-optimizer-model to obtain a recommendation of permissible/projected future total advertisement expenses for said retailer/service provider.

10. A programmed computer as in claim 9, wherein said advertisement-response model takes into account product sales share computed as
Share=>f{own retail ad expense,competitor retail ad expense,own brand ad expense,competitor brand ad expense,own promotions/incentives,competitor promotions/incentives}
said Share being expressed as equivalent to α+ΣβᵢXᵢ+γ
where
α=Constant
βᵢ=Coefficients
Xᵢ=Advertising Spend/(Advertising Spend+ρᵢ)
ρ=Share parameter value
γ=Error adjustment value, and
i=1 to number of advertising channels specified in the list;
wherein said demand-forecast model takes into account
(i) a product demand forecast that utilizes Holt-Winters method expressed as
y₍ₜ₊₁₎=(lₜ+bₜ)s₍ₜ₋ₘ₎+dₐ
z₍ₜ₊₁₎=(lₜ+bₜ)s₍ₜ₋ₘ₎+dₐ
where
y₍ₜ₊₁₎=Forecast for period+1
z₍ₜ₊₁₎=Share forecast for period+1
lₜ=Level equation
bₜ=Trend equation
sₜ=Seasonality equation
lₜ=α(yₜ/s₍ₜ₋ₘ₎)+(1−α)(lₜ₋₁+bₜ₋₁)
bₜ=β(lₜ−lₜ₋₁)+(1−β)bₜ₋₁
sₜ=γ(yₜ/(lₜ₋₁+bₜ₋₁)+(1−γ)sₜ₋ₘ
dₐ=linear demand adjustment for static events, incentives
y=normalized historical demand
m=12 for monthly seasonality, 4 for quarterly
α, β, γ are smoothing parameters, and
(ii) demand forecast considering Target sales and Target share wherein
Sₒ=μ(Σ_{t=0,m}(|Shareₜ−Shareₜ₋₁|)) and
Sₒ=Target share;
wherein said advertisement expense-optimizer model takes into account Ad-expense by media-channel as being represented by: f {Demand Forecast, Ad Response, Baseline Ad Spend} using optimization formulation Max Σ Sᵢ, where Sᵢ=share of product i
Sᵢ=α+ΣβᵢXᵢ+γ, subject to constraints
zₜᵢ<Sₜᵢ<(Sₜᵢ+Sₒ).

11. A programmed computer for increasing/optimizing retail market share/sales of a retailer/service provider for a known commodity and for decreasing/optimizing advertising expenses for said known commodity, comprising programmed modules:
a, for creating and entering into said programmed computer an advertisement-response model including parameters representing present/historical ad-expense, present/historical sales and present/historical promotions/incentives of said retailer/service provider to obtain at least a first output;
b. for creating and entering into said programmed computer a demand-forecast model including parameters of retailer's market sales, market share and economic indicators to obtain a second output, said at least first output being connected for ongoing processing; and
c. for using said first and second outputs as computerized inputs into an advertisement expense-optimizer model to obtain an optimized recommendation of permissible/projected future total advertisement expenses for said retailer/service provider.

12. The programmed computer as in claim 11 including modules for factoring (a) historical product/service Ad expense of said retailer by channel and (b) historical product/service Ad expense of a competitor by channel, to said advertisement-response model.

13. The programmed computer as in claim 12 including a module for factoring (a) historical product sales of said retailer by channel and (b) historical competitor sales into said advertisement-response model.

14. The programmed computer as in claim 13 including a module for factoring (a) historical product incentives of said retailer by channel and (b) historical competitor product incentives into said advertisement-response model.

15. The programmed computer as in claim 11 wherein said advertisement-response model generates a product share-response signal and wherein said product share-response signal is connected as input to said advertisement expense-optimizer model.

16. The programmed computer as in claim 11 wherein said advertisement-response model takes into account product sales share computed as
Share=Σf{own retail ad expense,competitor retail ad expense,own brand ad expense,competitor brand ad expense,own promotions/incentives,competitor promotions/incentives}
Share being expressed as equivalent to α+ΣβᵢXᵢ+γ
where
α=Constant
βᵢ=Coefficients
Xᵢ=Advertising Spend/(Advertising Spend+ρᵢ)
ρ=Share parameter value
γ=Error adjustment value, and
i=1 to number of advertising channels specified in the list.

17. The programmed computer as in claim 11 wherein said demand-forecast model takes into account
(i) a product demand forecast that utilizes Holt-Winters method expressed as
y₍ₜ₊₁₎=(lₜ+bₜ)s₍ₜ₋ₘ₎+dₐ
z₍ₜ₊₁₎=(lₜ+bₜ)s₍ₜ₋ₘ₎+dₐ
where
y₍ₜ₊₁₎=Forecast for period+1
z₍ₜ₊₁₎=Share forecast for period+1
lₜ=Level equation
bₜ=Trend equation
sₜ=Seasonality equation
lₜ=α(yₜ/s₍ₜ₋ₘ₎)+(1−α)(lₜ₋₁+bₜ₋₁)
bₜ=β(lₜ−lₜ₋₁)+(1−β)bₜ₋₁
sₜ=γ(yₜ/(lₜ₋₁+bₜ₋₁)+(1−γ)sₜ₋ₘ
dₐ=linear demand adjustment for static events, incentives
y=normalized historical demand
m=12 for monthly seasonality, 4 for quarterly
α, β, γ are smoothing parameters, and
(ii) demand forecast considering Target sales and Target share wherein
Sₒ=μ(Σ_{t=0,m}(|Shareₜ−Shareₜ₋₁|)) and
Sₒ=Target share.

18. The programmed computer as in claim 11, wherein said advertisement expense-optimizer model takes into account Ad-expense by media-channel as being represented by: f {Demand Forecast, Ad Response, Baseline Ad Spend} using optimization formulation Max ΣSᵢ, where Sᵢ=share of product i
Sᵢ=α+ΣβᵢXᵢ+γ, subject to constraints
zₜᵢ<Sₜᵢ<(Sₜᵢ+Sₒ).

19. A programmed computer as in claim 9, that is programmed to send a product-share response signal from said advertisement response model to said Ad expense optimizer model.

20. A programmed computer as in claim 19, programmed to send a predicted product share signal from said demand forecast model to said Ad expense optimizer model.
